(19) United States
(12) Patent Application Publication
(10) Pub. No.: US 2005/0076327 A1
(43) Pub. Date: Apr. 7, 2005

(54) Server-side wireless development tool

(75) Inventors: Abdelsalam G. Helal, Gainesville, FL (US); Dushiant Kochhar, Bellevue, WA (US)

Correspondence Address: AKERMAN SENTERFITT, P.O. BOX 3188, WEST PALM BEACH, FL, 33402-3188, US

(73) Assignee: University of Florida, Gainesville, FL (US)

(21) Appl. No.: 10/758,180

(22) Filed: Jan. 15, 2004

Related U.S. Application Data
(60) Provisional application No. 60/440,156, filed on Jan. 15, 2003.

(51) Int. Cl. G06F 9/44

(52) U.S. Cl. 717/100; 717/106

(57) ABSTRACT

An integrated development tool for constructing a server-side proxy for interacting with a wireless, mobile device can include at least one module. The module can be configured to generate program code to perform a specific function of the server-side proxy. The integrated development tool also can include means for accessing the at least one module.

### CROSS-REFERENCE TO RELATED APPLICATIONS

This application claims the benefit of U.S. Provisional Application No. 60/440,156, filed in the United States Patent and Trademark Office on Jan. 15, 2003, the entirety of which is incorporated herein by reference.

### BACKGROUND

1. Field of the Invention

The present invention relates to the field of application development for wireless mobile devices and, more particularly, to developing the server-side components which interact with wireless mobile devices and mobile clients.

2. Description of the Related Art

Mobile Devices have characteristics that differ significantly from the desktop environment. For example, mobile devices often are characterized by small displays, low processor power, less memory, and low bandwidth communications links. Further complicating matters, characteristics such as display size and bandwidth can vary not only among devices, but also among communications protocols.

Accordingly, mobile applications tend to be small and have a relatively small memory footprint. The mobile applications must be able to operate in a low bandwidth environment. Still, such applications must be able to adapt to changing user interfaces and bandwidth availability. In consequence, most mobile applications make use of a proxy. The proxy acts as an interface between the mobile application or client and one or more other servers. The proxy can perform a variety of processing functions to aid the mobile application.

FIG. 1 is a schematic diagram illustrating an exemplary communications system 100 having a mobile device 105, a mobile application (or client) 110 disposed therein, and a proxy 115 which can communicate with a Universal Description, Discovery, and Integration (UDDI) registry 135, one or more Web sites and/or servers 140, and one or more Web Services 145. Generally, the proxy 115 has two interfaces, a client interface 120 and a server interface 125. The client interface 120 interacts with the mobile client 110 and receives requests as well as sends responses. The client interface 120 can use a limited number of protocols due to limitations of the client. The server interface 125 can communicate with a variety of different servers to fetch data. The server interface 125 can use a number of protocols such as Transmission Control Protocol (TCP), User Datagram Protocol (UDP), Simple Object Access Protocol (SOAP), and the like. The proxy 115 can include a third component referred to as an adaptation module 130 which can transform data according to the needs of the mobile client 110. The adaptation module 130 helps reduce the processing burden not only on the mobile client 110, but also on the servers. Notably, the servers, for example Web sites 140, provide information to both mobile clients and desktop clients.

At a fundamental level, proxies forward data from servers to mobile clients. More complex proxy functionality can include the adaptation of a server output stream to a format and bandwidth that is suitable for use by the mobile client. Proxies also can be configured to track the position of the mobile client.

Consumer demand for wireless services and network-aware applications has fueled a trend to release more applications with ever decreasing design cycles and reduced time to market. Still, the development of wireless applications requires a significant amount of effort not only with respect to developing the mobile client, but also with regard to developing the necessary proxy counterpart to the mobile application client. That is, often, the release of a new application or service requires the development of a new proxy for that application, thereby potentially doubling the necessary design time. The development of a proxy can demand the same commitment of resources as is required for the development of the mobile client. Moreover, the development of a robust proxy is essential if the mobile client is to provide significant services to the user.

Client side development has been addressed through tools and platforms such as Java 2 Micro Edition (J2ME), which provides a minimal configuration of a Java virtual machine and application programming interfaces (API's) that embody essential capabilities for a mobile device. Although a number of different tools exist for client-side development, for example the J2ME Wireless Toolkit available from Sun Microsystems of Santa Clara, Calif., and CODEWARRIOR from Metrowerks, of Austin, Tex., a need exists for an integrated development environment for the development of proxies for use with network aware applications and other applications for mobile devices.

### SUMMARY OF THE INVENTION

The inventive arrangements disclosed herein provide an interactive development environment (IDE) and toolkit for the development of a server-side proxy for use with wireless, mobile clients. Accordingly, the present invention provides a complete infrastructure allowing a developer to efficiently develop a server-side application or proxy to compliment a client side development kit.

The present invention provides a complete and integrated development environment for the developer which can include an editor and a debugger. Additional features can be provided by incorporating aspects of the present invention within an existing development environment as is commercially available from third party developers. For example, a toolbar can be provided within an existing IDE. The toolbar can provide information about the API as well as automatically generate code in accordance with developer specified parameters. In consequence, manual coding of the proxy is minimized as several code generators are provided for developing a proxy shell.

One aspect of the present invention can include an integrated development tool for constructing a server-side proxy for interacting with a wireless, mobile device. The integrated development tool can include at least one module configured to generate program code to perform a specific function of the server-side proxy. The integrated development tool further can include means for accessing the module(s).

In one embodiment of the present invention, the means for accessing functions can include a wizard module for receiving user specified attributes of the server-side proxy. The wizard module can control operation of the module(s) to automatically generate program code specifying a programmatic architecture for the server-side proxy according to the user specified attributes. In another arrangement, the means for accessing functions can include a toolbar having at least one icon that can be activated via user input.

In another embodiment, the integrated development tool can include a module configured to generate program code to extract text from a markup language document. The integrated development tool also can include a module configured to generate program code to packetize data according to a type of wireless communications link over which the data is to be sent. Other exemplary modules that can be included within the integrated development tool can include, but are not limited to, a module configure to generate program code to convert images from a first graphics format to a second graphics format, wherein the second graphics format is suitable for transmission over a wireless communications link to a mobile device, a module configured to generate program code to receive a request originating from the mobile device and generate a hypertext transfer protocol request to an appropriate target, and a module configured to generate program code to maintain user profiles within a data source accessible to the server-side proxy.

The integrated development tool also can include a module configured to generate program code to manipulate data strings for encoding and decoding data and a module configured to generate program code to measure a quality of a communications link to the wireless, mobile device. Still, the integrated development tool can include a module configured to search a Universal Description, Discovery, and Integration registry.

The integrated development tool further can include one or more standardized Web Services Description Language documents, wherein each Web Services Description Language Document corresponds to a particular domain.

Another aspect of the present invention can include a method of constructing a server-side proxy for interacting with a wireless, mobile device. The method can include receiving user input specifying attributes of the server-side proxy and automatically generating program code specifying an architecture for the server-side proxy according to the user specified attributes. The program code can be generated by a plurality of modules, each module configured to generate code to perform a particular function of the server-side proxy.

In one embodiment of the present invention, the automatic generating step can include generating program code to extract text from a markup language document, generating program code to packetize data according to a type of wireless communications link over which the data is to be sent, or generating program code to convert images from a first graphics format to a second graphics format, wherein the second graphics format is suitable for transmission over a wireless communications link to a mobile device.

Still, the automatic generating step can include generating program code to receive a request originating from the mobile device and generate a hypertext transfer protocol request to an appropriate target, generating program code to maintain user profiles within a data source accessible to the server-side proxy, generating program code to manipulate data strings for encoding and decoding data, or generating program code to measure a quality of a communications link to the wireless, mobile. device. The integrated development tool also can include searching a Universal Description, Discovery, and Integration registry.

Other embodiments of the present invention can include a system for constructing a server-side proxy for interacting with a wireless, mobile device having means for performing the various functions described herein as well as a machine readable storage configured to cause a machine to perform the various steps disclosed herein.

### BRIEF DESCRIPTION OF THE DRAWINGS

There are shown in the drawings embodiments which are presently preferred, it being understood, however, that the invention is not limited to the precise arrangements and instrumentalities shown.

FIG. 1 is a schematic diagram illustrating an exemplary communications system having a mobile client and a proxy.

FIG. 2 is a schematic diagram illustrating an exemplary mobile toolbar in accordance with the inventive arrangements disclosed herein.

FIG. 3 is a schematic diagram illustrating exemplary selection lists which can be presented upon activation of a button within the mobile toolbar of FIG. 2.

FIG. 4 is a schematic diagram illustrating an exemplary graphical user interface (GUI) which can be presented upon activation of a button within the mobile toolbar of FIG. 2.

FIG. 5 is a schematic diagram illustrating another exemplary GUI which can be presented upon activation of a button within the mobile toolbar of FIG. 2.

FIG. 6 is a schematic diagram illustrating an exemplary GUI for use with the mobile proxy component of the present invention.

FIG. 7 is a schematic diagram illustrating another exemplary GUI for use with the mobile proxy component of the present invention.

FIG. 8 is a schematic diagram illustrating another exemplary GUI for use with the mobile proxy component of the present invention.

FIG. 9 is a schematic diagram illustrating yet another exemplary GUI for use with the mobile proxy component of the present invention.

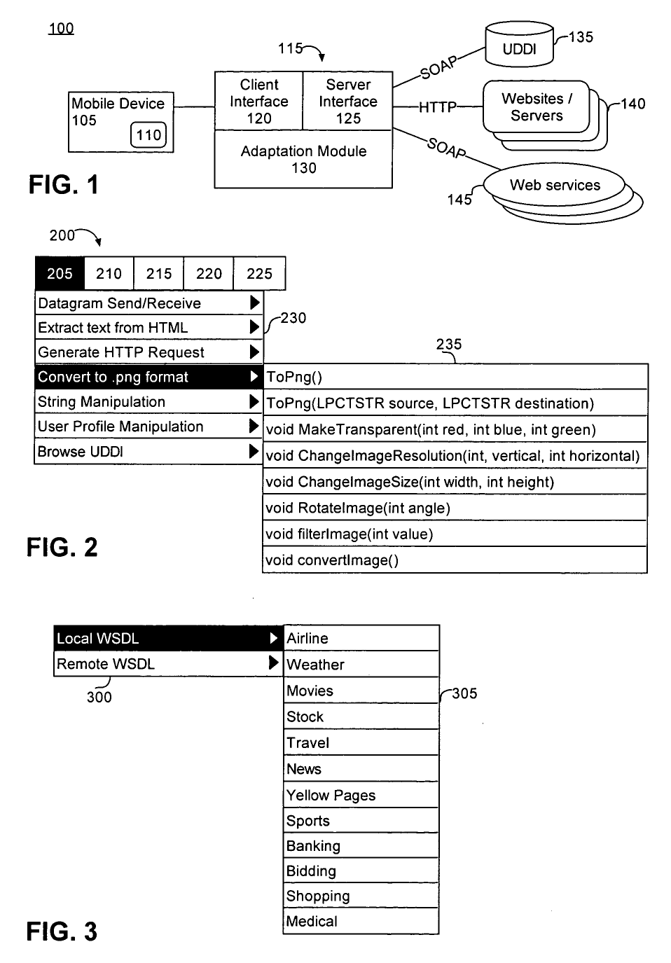

### DETAILED DESCRIPTION OF THE INVENTION

The present invention provides an interactive development environment and accompanying tools (hereafter collectively the “proxy IDE”) for developing a server-side proxy which can interact with a network aware, wireless, mobile client application. The proxy IDE can provide a variety of functions and code generation tools which expedite the development of a proxy for a wireless application. For example, the proxy IDE can provide a range of functions including, but not limited to, text extraction from Hypertext Markup Language (HTML) and Extensible Markup Language (XML) data, datagram packetization, image format conversion, Hypertext Transfer Protocol (HTTP) request support, user profile management, as well as string manipulation.

The functions disclosed herein can be provided through an application programming interface (API). Within the development environment, a toolbar referred to as a “mobile toolbar” can be provided. Additionally, a mobile proxy component for developing a proxy shell can be included. Still, a complete integrated environment containing an editor, a debugger, a compiler, and a host of other features is provided.

The following provides a more detailed description of various API's or components that can be included in the proxy IDE. According to one embodiment of the present invention, the API can be configured such that all classes of the API are implemented as Extension DLLs using Microsoft Foundation Class Library. Although the present invention can be implemented using the C++ programming language, more particularly the Visual C++ programming language, those skilled in the art will recognize that any of a variety of object oriented programming languages can be used, for example the Java programming language.

As such, the following exemplary API's and corresponding syntax are provided for purposes of illustration only, and are not intended to be a limitation of the present invention with regard to the functionality provided or the particular programming language used. Moreover, as the present invention can be used to generate a proxy which communicates with mobile clients using datagrams, those skilled in the art will recognize that the mobile client need not be programmed using the same programming language as that of the proxy. The present invention can be used to develop proxies for use with the Java 2 Micro Edition (J2ME) platform or another platform suited to wireless mobile application development and services.

The proxy IDE can include a text extraction API or module for extracting text from HTML and XML documents. The text extraction API can support the extraction of text from designated ranges of one or more markup language documents. The ranges can be specified by particular tag sets which indicate the start and end point for performing text extraction. Websites typically provide HTML and/or XML formatted responses over low bandwidth communication links. Moreover, HTML and XML documents can be large in comparison with the amount of bandwidth available for transmission of the documents to a mobile client. Accordingly, only a select amount of data need be passed on to the mobile client. The proxy IDE can provide an API for extracting text from various markup language documents. The following is an exemplary listing of text extraction functions that can be included within a proxy shell by the proxy IDE.

| Method Name | Function performed |
|---|---|
| HtmlTOText( ) | Creates an object. |
| CString* GetText(LPCTSTR | Takes source string in HTML format, |
| xource, LPCTSTR search, int | the string to search for in the source |
| start, int end) | code, and the start and end positions of |
| | the string to be returned from the point |
| | where the search string was found. |
| CString* GetText( CStdioFile* | Same as the previous method with the |
| source, LPCTSTR search, int | exception that a reference to the |
| start, int end) | CStdioFile object is used, for example, |
| | as a first parameter instead of a string. |
| CString* GetText( LPCTSTR | Returns a pointer to the CString object |
| source, LPCTSTR tag) | for the text between the tags whose |
| | name is given by the second parameter. |
| | For example, if the tag name is TITLE, |
| | data between < TITLE > and |
| | < /TITLE > will be returned from the |
| | source. |
| CString* GetText( CStdioFile* | Same as the previous method with the |
| source, LPCTSTR tag) | exception that a filename is used as the |
| | first parameter instead of a string. |
| void RemoveTag( CString | Removes the given tag from the source. |
| *source, LPCTSTR tag) | The second parameter should be the full |
| | tag name (e.g., < TITLE >). |
| void RemoveTag( CStdioFile* | Same as the previous method with the |
| source, LPCTSTR tag) | exception that a filename is used as the |
| | first parameter instead of a string. |

The proxy IDE can include a datagram packet API or module for fragmenting strings into smaller units which can be sent over a wireless communications link. For example, the maximum transmission unit of the wireless communications link usually falls short of the capacity to handle the length of strings which often must be sent to the mobile client. In consequence, the proxy must be configured to fragment the string into a unit having a length that can be handled by the wireless communications link. These packets must be assembled in correct order in the mobile client. The datagram packet API of the proxy IDE allows developers to specify a particular length for fragmentation and specify routing of the fragmented data to a given destination address and port number. The API further enables developers to send messages as universal data packets to a destination. The following is an exemplary listing of datagram packetization functions that can be included within a proxy shell by the proxy IDE.

| Method Name | Function performed |
|---|---|
| DtgrmSendRcv( ) | By default, the length of data bytes sent is |
| | 1024. |
| DtgrmSendRcv(int length) | The length of data bytes to be sent is |
| | assigned by the user. |
| bool send(CString message, | Accepts a message as a CString object, |
| LPCTSTR destination, int | destination address, and port number of the |
| port) | destination. Returns true or false depending |
| | upon whether the action is successful. |
| | Includes packet number and total number of |
| | packets in front of each and every packet |
| | sent. The format of the packet sent is |
| | < packet-number > # < total packets > |
| | #data. |

The proxy IDE also can include an image processing API or module. As most mobile devices, such as wireless telephones, have a limited ability to handle and process graphics, proxies typically perform any necessary format conversion of graphic images. The image processing API allows a developer to request conversion of images from any of a variety of formats, for example GIF, JPEG, BMP, or the like, to Portable Network Graphics (PNG) format. Notably, the image processing API can include functions for increasing or decreasing the size of an image, increasing or reducing the resolution of an image, rotating the image, and/or filtering the image so that the client device can display and handle the image properly. The following is an exemplary listing of image processing functions that can be included within a proxy shell by the proxy IDE.

| Method Name | Function performed |
|---|---|
| ToPng(LPCTSTR source, | Receives a complete pathname of the |
| LPCTSTR destination) | source and the destination filenames. |
| | A double slash instead of a single slash |
| | should be provided in the pathname (e.g., |
| | “c:\\Program Files\\2png\\logo1.gif” |
| | instead of “c:\Program Files\2png\ |
| | logo1.gif”). |
| void MakeTransparent(int red, | Make one or several colors transparent. |
| int blue, int green) | The range of each parameter is between 0 |
| | and 255. |
| void | Changes the vertical and the horizontal |
| ChangeImageResolution(int | image resolution given by Vertical and |
| vertical, int horizontal) | Horizontal parameters. |
| void ChangeImageSize(int | Changes the vertical image size. |
| width, int height) | |
| void RotateImage(int angle) | Rotates the image by Angle given in |
| | degrees. |
| void filterImage(int value) | Value should be between 0 and 5, where |
| | different possible filters can include blue, |
| | sharpen, emboss, water color, smoothing |
| | noise, maximum, and minimum. After |
| | providing the settings of the PNG file |
| | using the above methods, the following |
| | method should be used to convert the |
| | image. |
| void convertImage( ) | Produces the final PNG formatted image. |

The proxy IDE can include an API or module for decoding requests originating in the mobile client and generating HTTP requests to connect to the appropriate server to acquire data. Accordingly, the proxy IDE can include an API for generating an HTTP query. Notably, the API can accommodate various options which specify whether data is to be requested at periodic time intervals either in a string or in a file. For example, at times, the cache of data on the proxy requires refreshing at periodic intervals. From time to time, data also may need to be resent to the mobile client. In either case, requests must be periodically sent to the server with the appropriate parameters. This involves making HTTP requests and creating connection-using threads—both functions which can be addressed by the HTTP processing API of the proxy IDE. The following methods provide different options for fetching data from a given Website. The following is an exemplary listing of request decoding and generation functions that can be included within a proxy shell by the proxy IDE.

| Method Name | Function performed |
|---|---|
| httpQuery(CString source) | |
| httpQuery(CString source, | |
| LPCTSTR) | |
| httpQuery(CString source, | The first parameter in all cases is the source |
| LPCTSTR file, DWORD | website from which the data needs to be |
| interval) | fetched. The second parameter, wherever |
| | applicable, is the complete pathname of the |
| | file to which the response is uploaded. The |
| | path should be specified with two |
| | backslashes like c:\\Program Files\\log.txt” |
| | instead of “c:\Program Files\log.txt”. |
| | Interval. Internal, the third parameter in the |
| | last constructor, is the interval in |
| | milliseconds after which the file is updated |
| | regularly from the source. |

The following methods can be provided by the “httpQuery” class:

| Method Name | Function performed |
|---|---|
| CString* getRespInStr( ) | Used with the first constructor and provides |
| | response in the CString reference. |
| BOOL getRespInFile( ) | Used with the second constructor and |
| | provides the response in the file given in |
| | the constructor. |
| void getRespInFileAtIntv( ) | Used with the third constructor and provides |
| | the response in the file given in the |
| | constructor. Also updates the file after every |
| | interval given by the parameter Interval in |
| | the constructor. |
| void stopThread( ) | Used with getRespInFileAtIntv method to |
| | stop the thread that refreshes the file after |
| | every Interval. |

The proxy IDE can include an API or module for maintaining user profiles within a data store such as a database. The API can provide functions for storing, selecting, deleting, managing, editing, and updating user profiles which specify names, addresses, telephone numbers, and other user specific preferences. User profiles can specify particular data items to be sent and which data items are not to be sent. Additionally, user profile functions allow users to avoid having to re-enter user specific data and aid in billing services. Accordingly, the user profile API provides the developer with methods to maintain user profiles.

The API also can provide classes to maintain client profiles. For purposes of the following discussion, the term “user” refers to mobile client. For this, a “Profile” database can be created having tables: Address, Property, and UserName. The tables can be used to maintain addresses and properties pertaining to client and client names. For this API to function properly, the system must include a user profile database as well as Open Database Connectivity (ODBC) drivers for the selected database product. The following is an exemplary listing of classes that can be included in this API and the methods associated therewith.

An “address manipulation” class can provide methods to select, update, and delete an address of the client based on “userid”. The class can include:
AddressManipulation( )
bool ChangeAddress(int userid, Address newaddr)
bool DeleteAddress(int userid)
Address* GetAddress(int userid)

A “profile manipulation” class can be used to add or get a client profile. The profiles can include a client name and address. The following are methods which can be included in the “profile manipulation” class:
ProfileManipulation( )
int AddProfile(CString Name, Address addr)
Profile* GetProfile(int userid)
bool DeleteProfile(int userid)

A “property manipulation” class can be used to maintain properties of the mobile client or the mobile client device. A property can be anything which provides details of the client device. Exemplary properties can include, but are not limited to, “display” which can indicate whether a device is a color device. Other properties can indicate particular tastes of the client. For example, “movies” can be set to comedy, action, drama, or the like. The following are the methods which can be included in the “property manipulation class”:
PropertyManipulation( )
bool AddProfileProperty(int userid, LPTSTR pname, LPTSTR pvalue)
bool ModifyPropertyValue(int userid, LPTSTR pname, LPTSTR pvalue)
bool DeleteProperty(int userid, LPTSTR pname)
CString* GetPropertyValue(int userid, LPTSTR pname)

The proxy IDE also can include an API or module for accessing string manipulation functions for encoding and decoding data. For example, taking the case where data from the wireless client to the server and vice versa is sent in UDP packets without any structural information, one does not know how to separate the data at the opposite end. To separate data at the receiving end, applications typically utilize a protocol which describes the position of particular fields within packets. As data is sent to the proxy from the client and vice versa, delimiters can be inserted at the sending location to separate multiple fields. These fields can be recovered at the receiving end based on the delimiters. The string manipulation API provides interfaces to encode and decode the data using delimiters and includes the class “StrManip”, which includes constructors and methods. The following is an exemplary listing of string manipulation functions that can be included within a proxy shell by the proxy IDE.

| Method Name | Function performed |
|---|---|
| StrManip( ) | Default delimiter is “\hat{ }”. |
| StrManip(TCHAR delimiter) | Takes the delimiter to encode the data |
| | in string. |
| StrManip(CString | Takes the string to tokenize, i.e. to |
| *StrToToken) | extract data out of the string. The |
| | delimiter is the default “\hat{ }”. |
| StrManip(CString | Same as the previous method with the |
| *StrToToken, TCHAR | exception being that a delimiter is |
| delimiter) | provided by the user. |
| CString* AddString(LPCTSTR | Encodes the data using the delimiter |
| addition) | defined during the construction of the |
| | object. It should be used with the first |
| | two constructors. |
| CString* getToken( ) | Extracts tokens from string using the |
| | delimiter defined during the |
| | construction of the object. |

The Universal Description, Discovery, and Integration (UDDI) browse API or module can provide methods to search the UDDI registry. Limitations of mobile clients make it difficult to inquire deep into the UDDI architecture, communicate with different points, and communicate using Simple Object Access Protocol (SOAP). The proxy, however, can be provided with the functionality necessary to access the UDDI registry, connect to the access point, and fetch the data, thereby acting as a gateway for the mobile client.

The UDDI browse API can provide both find and get API classes to query the UDDI registry on the basis of businessEntity, businessService, bindingTemplate, and tModel. For each class, different methods can be provided to add identifiers and categories to the search criteria. The program can be developed such that the ability to query the UDDI registry in depth is performed at run time. According to one embodiment of the present invention, a communications link with a UDDI portal can be established. The various classes of the UDDI browse API can include, but are not limited to:

1. findBusiness—This class can provide options to search the UDDI registry based upon a business name. The constructors and methods can include:
findBusiness( )—Initializes the object.
void AddName(CString name)—Used to add the name of the business for which the search has been undertaken. The following four methods further refine the search criteria.
void Addidenti_erBag(CString identifier)
void AddCategoryBag(CString category)
void AddtModelBag(CString tmodel)
void AddDiscoveryURLs(CString discoveryURL)
CHttpFile* getResponse( )—This method is executed at the end to fetch the response from the UDDI registry. The method returns a reference to the resultant file.

2. findService—Provides options to search the UDDI registry based upon a business key. The method can return all services provided by that business.
findService(CString businesskey)—Takes the business key for the business whose services are to be searched.
void AddName(CString name)—Adds the service name to the request.
   The following two methods further refine the search criteria.
void AddCategoryBag(CString category)
void AddtModelBag(CString tmodel)
CHttpFile* getResponse( )—This method is executed at the end to fetch the response from the UDDI registry. The method returns a reference to the resultant file.

3. findBinding—This class can provide methods to find binding details for a service.
findBinding(CString servicekey)—Takes a service key whose binding needs to be searched.
void AddtModelKey(CString tmodelkey)—This method enables one to add tModel key for tModel bag.
CHttpFile* getResponse( )—Returns reference to the file containing the response.

4. findtModel—Enables a search for tModel. The class has the following constructors and methods.
findtModel( )
void AddName(CString name)
void AddIdenti_erBag(CString identifier)
void AddCategoryBag(CString category)
CHttpFile* getResponse( )—This method returns a reference to the file containing the response.

The next four classes can be used to obtain details for any of the four data structures, business, service, binding, and tModel, used in the UDDI registry. The following is a list of exemplary constructors and methods which can be present in each class.

5. getBusinessDetail
getBusinessDetail(CString businesskey)
CHttpFile* getResponse( )

6. getServiceDetail
getServiceDetail(CString servicekey)
CHttpFile* getResponse( )

7. getBindingDetail
getBindingDetail(CString bindingkey)
CHttpFile* getResponse( )

8. gettModelDetail
gettModelDetail(CString tModelKey)
CHttpFile* gettModelDetail::getResponse( )

Constructors in each case can take the key for that data structure whose details are to be found. The getResponse( ) method can fetch the response from the UDDI registry. The above classes can provide standard UDDI search methods. The first four classes can be used to search on the basis of business, service, binding or tModel, while the last four classes can be used to obtain details for each category.

Another class in this category is the getServices class.

9. getServices—Allows searching of the registry based upon either keyword or tModel. The class can return the following information in the form of an array of ServiceDetails objects:
(a) Service Key—Service key of a service whose name matches either keyword or whose tModelBag contains the tModel key provided.
(b) Service Name—The service name.
(c) Description—Description of the service.
(d) Business Name—Business name providing this service.
(e) Business Key—Business key for that business house.
(f) Access Point—The access point where that service can be accessed.
(g) Overview URL—This URL gives the location where technical details of the service can be found.
(h) Binding Key—This is the binding key of the service.
(i) tModel Key—This is the tModel key for the service.

The getServices class can include the following constructors and methods.
getServices(CString word, int id)—Word can be a keyword or a tModel depending upon the second parameter id. id can have a value of 1 signifying the word is a keyword or 2 signifying that the word is a tModel.
ServiceDetails* Execute(int& size)—This can return an array of ServiceDetails class objects. Size denotes the size of the array returned.

Class ServiceDetails can include the methods to extract the values returned by the above Execute( ) method.

The proxy IDE can include a toolbar component through which a variety of different functions can be provided. FIG. 2 is a schematic diagram illustrating an exemplary mobile toolbar 200 in accordance with the inventive arrangements disclosed herein. According to one embodiment of the present invention, the mobile toolbar can be incorporated into an existing development environment such as a C++, Java, or other object oriented programming environment. For example, the mobile toolbar can be an add-in for Visual C++ IDE 6.0. As shown, the mobile toolbar 200 can include a plurality of activatable icons or buttons 205, 210, 215, 220, and 225.

As shown, activation of button 205, referred to as the API methods button, can cause the set of API's provided herein, and listed as selections 230, to be displayed along with the classes and the methods of each set. Upon selecting “Convert to .png format”, the constructors as well as the methods for the selected API can be presented as selections 235. Responsive to selection of one of the methods, code for that method and for calling to that method can be inserted at the current cursor position in an editor window of the proxy IDE. The parameters taken by each method and in addition to the data type of the parameters can be listed as shown.

Activation of button 210, referred to as the WSDL documents button can provide two options to the developer. FIG. 3 is a schematic diagram illustrating exemplary selection lists which can be presented upon activation of button 210. Selection box 300 is presented to allow the user to select either a local WSDL or remote WSDL option. Upon selecting the local WSDL option, a second selection box can be presented which allows the user to select a preconfigured WSDL document. More particularly, by selecting the local WSDL option, the names of all services can appear whose WSDL documents are written or specified within the proxy IDE. The selected WSDL document can be displayed in an output window of the proxy IDE.

The importance of WSDL with regard to Web services is greatly enhanced if standard WSDL documents are defined for specific industries. If interfaces are standardized through WSDL and service providers adhere to them, then the service users can switch from one vendor to another in the event that one vendor stops providing a given service. The user programs should continue to function. Accordingly, the following represents 12 exemplary services, for which WSDL documents can be provided within the proxy IDE.

1. Airline WSDL document can provide detail on the operations involved in airline reservation systems, the messages exchanged, and the message parameters. An exemplary airline WSDL is shown in the Appendix.

2. Movie WSDL document can provide operations for queries about movie releases for developers and users of the service.

3. News WSDL document can provide details on how news should be implemented and accessed.

4. Stock WSDL document can provide details on how services related to stock queries should be implemented and accessed.

5. Travel WSDL document can provide details on travel information services such as hotel reservations and room availability.

6. Weather WSDL document for use by both service providers and users of a weather service.

7. Yellow Pages WSDL document can provide functionality similar to conventional yellow pages.

8. Sports WSDL document.

9. Shopping WSDL document can provide different messages and operations involved in shopping.

10. Medical WSDL document can provide information such as doctor availability, scheduling an appointment, and other medical service functions.

11. Banking WSDL document can specify an interface.

12. Bidding WSDL document can specify an interface.

The WSDL documents for different services can be registered as tModels with a UDDI registry. Vendors interested in mobilizing their services can adhere to these tModels. On the other hand, the application developer can search the UDDI registry on the basis of these tModels. Additionally, programs can be developed in such a way that if one access point for a service is not working, the program automatically looks for a different access point.

The second option is to look for remote WSDL documents. In that case, the developer must provide a complete Website address where that WSDL document is located. The document can be fetched from the source and displayed in a window of the proxy IDE. Displaying the document within the IDE is advantageous since the developer can refer to the document while writing code.

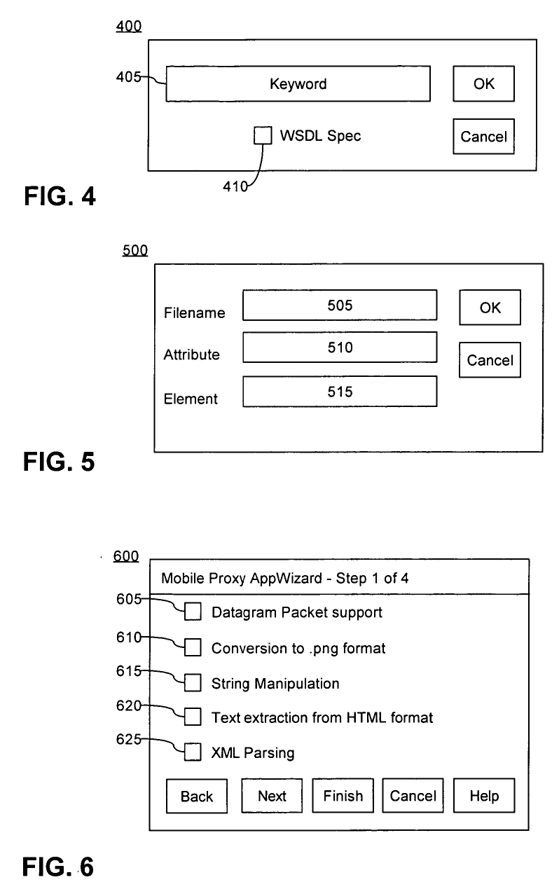

Activation of button 215, referred to as the UDDI search button, can cause a dialog box for performing a UDDI registry search to be displayed. FIG. 4 is a schematic diagram illustrating an exemplary GUI 400 which can be displayed responsive to activation of button 215. The GUI 400 can include a data entry field 405 for receiving a developer specified keyword. The developer can choose to search only those services whose technical specification is explained using WSDL documents by selecting check box 410.

Searching on the basis of a keyword can yield all of those services whose names contain the keyword. The services are returned from the UDDI registry along with complete details of the business providing that service, service access point, and overview uniform resource locator (URL), which provides information about how to use the service. In most cases, the overview URL points to the location from which the WSDL document can be fetched. Developers further can specify whether the search should include only those services whose technical details are given by the WSDL document.

Still, a developer can search on the basis of a tModel, for which another GUI can be presented. Searching on the basis of a tModel allows the developer to specify the tModel for the service being sought. The search can be made for all services that contain that particular tModel in their tModelBag. The tModel should be specified without the initial “uuid:”. For example, the tModel can be specified as “61D9BB17-841D-4170-BC24-E65A283F6ED2” rather than as “uuid:61D9BB17-841D-4170-BC24-E65A283F6ED2”. The output can be displayed in a window of proxy IDE.

Activation of button 220, referred to as the insert code button, provides options for inserting code corresponding to different functionalities at the current cursor position. Accordingly, a developer can be queried for specific variable names. Once specified, the code can be automatically generated. For example, according to one embodiment of the present invention, the following options can be provided.
The image format conversion option can query the developer for an object name for the class ToPng, the source filename that needs to be converted to PNG format, the target filename of the converted file, and the height and the width of the target PNG file. The proxy IDE can insert code in the editor at the current cursor position.
The extract tokens option can prompt the developer for the object name of StrManip class, source code which needs to be tokenized, and the delimiter for which source needs to be tokenized, so as to insert code for tokenizing the string. The token values generated can be assigned to the variable token.
The HTTP request option can provide the developer with a dialog box to enter an object name for the class httpQuery, source from which to fetch the data, a filename from which to fetch the data, and the interval after which data needs to be fetched.
The text extraction from HTML file option can prompt the developer for an object name for HtmlTOText class, filename from which data needs to be extracted, tag name, and start and end position for the data to be extracted from the string.
The text extraction from HTML string option is similar to the previous option with the exception that the source is a string instead of a file.
The parse an XML file option can query the developer about the XML file that requires parsing, as well as the element name and the attribute name whose value is required. FIG. 5 is a schematic diagram illustrating an exemplary GUI 500 which can be displayed to query a developer for information required for XML parsing. Data field 505 can receive a filename of a file containing data in XML format. Data field 510 can receive an attribute name whose value needs to be extracted. Data field 515 can receive a node element name whose text needs to be extracted. The following comments can be inserted in the code to inform the developer as to which variables contain the element value and the attribute value: (1) //Use bstrItemText which contains the Element text, or (2) //Use bstrItemText which contains the Attribute Value.
The send datagram option can trigger a dialog box which asks the developer for the object name of the DtgrmSendRcv class, the string to be sent, and the destination Internet Protocol (IP) address and port.
The database operations option can provide the developer with four options: select, update, insert, and delete. The operations pertain to data manipulation as well as data retrieval from a database. In each case, the developer can be prompted for a CDatabase object and corresponding statement.

Activation of button 225, referred to as the about proxy IDE button, provides information about the proxy IDE and/or the current development project.

The proxy IDE further can include a “Wizard” component for generating a shell for a proxy which conforms to options selected by the developer. The mobile proxy component can provide the following options to a developer for generating a proxy shell:
1. Datagram Packet
2. Conversion to PNG format
3. String manipulation
4. Text Extraction from HTML format
5. XML parsing
6. HTTP access to a website
7. Web Services Access
8. Database Support
9. User Profile Management
10. Address Management
11. Client Property Management

Still, it should be appreciated that the above listing is provided for purposes of illustration only. As such, additional options and functions can be included within the proxy IDE and presented. In any case, for each of the above options, with the exception of the database support option, appropriate headers and software code can be included in the generated application proxy shell. The last option for the developer to choose is the target device whose display size and display color are to be included in the project.

FIG. 6 is a schematic diagram illustrating an exemplary GUI 600 for use with the mobile proxy component of the present invention. As shown, the GUI 600 can include selectable options for generating software code for performing various functions to be included within a proxy shell. Selection of the appropriate option can include header files corresponding to the selected API or module to be inserted. Thus, selection of option 605 can include support or software code in the proxy shell for processing datagram packets. Selection of option 610 can include support for image conversion to *.png format. Selection of option 615 can include support for string manipulation in the proxy shell. Selection of option 620 can include support for text extraction from HTML code in the proxy shell. Selection of option 625 can include support for XML parsing in the proxy shell. Notably, the aforementioned functions can be provided by the proxy IDE or can be included from other software development kits as may be provided from third party manufacturers.

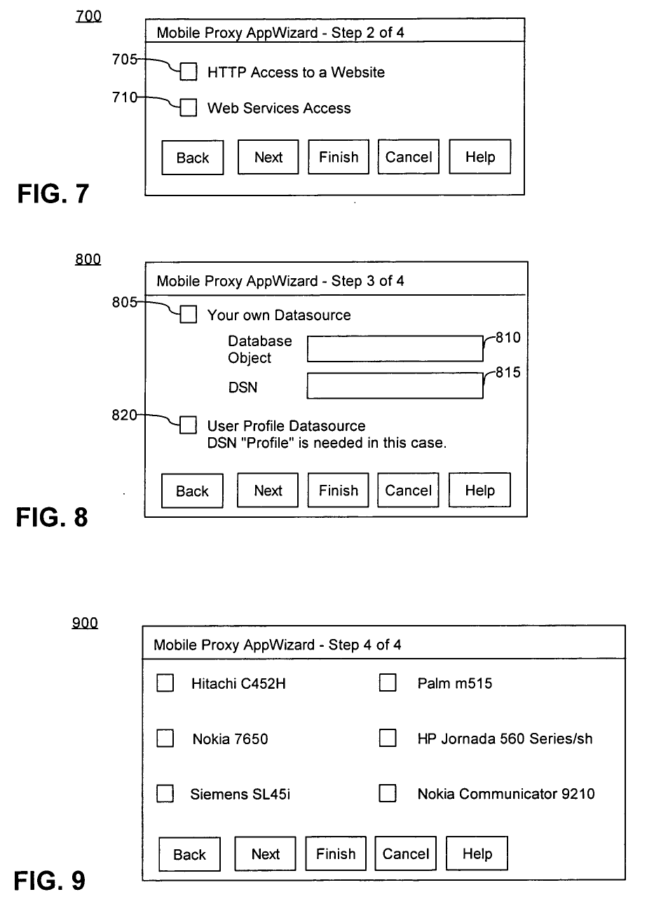

FIG. 7 is a schematic diagram illustrating an exemplary GUI 700 for use with the mobile proxy component of the present invention. The GUI 700 can be displayed responsive to selection of the “Next” button in FIG. 6. As shown, GUI 700 can include two selectable options. Selection of option 705 can include header files within the proxy shell for the HTTP API. Selection of option 710 can include header files within the proxy shell for the Web Services API which can include support for SOAP, WSDL, and UDDI.

FIG. 8 is a schematic diagram illustrating an exemplary GUI 800 for use with the mobile proxy component of the present invention. The GUI 800 can be displayed responsive to selection of the “Next” button in FIG. 7. The GUI 800 can include a selectable option 805 wherein a developer can specify a datasource. For example, if option 805 is selected, data fields 810 and 815 can be enabled for receiving a database source and an ODBC Data Source Name (DSN) name for that source. Alternatively, the developer can select option 820, which is the user profile API which uses “Profile” DSN.

FIG. 9 is a schematic diagram illustrating an exemplary GUI 900 for use with the mobile proxy component of the present invention. The GUI 900 can be displayed responsive to selection of the “Next” button in FIG. 8. As shown in FIG. 9, the GUI 900 includes a variety of selectable options for specifying a target client device. By selecting the appropriate client device option, the display length, display width, and display color of the device can be included in the proxy shell, for example as specified within a device profile included in the proxy IDE. Notably, the “Next” button of GUI 900 can be disabled. After going through the steps discussed in reference to GUIs 600, 700, 800, and 900 respectively, a proxy shell can be generated in accordance with the options selected in the aforementioned GUIs. For example, the proxy shell can be generated as a project within the proxy IDE.

The wizard can generate several files for the developer as explained in further detail below. The mobile proxy component can generate Listener.cpp and Listener.h files. These files provide all of the functionality of the server, which continuously listens for the client requests at a default port, for example port 5995. For this purpose, a datagram socket can be used. When a datagram packet is received, a new thread that creates a new Worker class object can be instantiated. The Worker class object passes the thread the data along with the client's IP address and port number.

The mobile proxy also can generate Worker.cpp and Worker.h files. This class can provide a run( ) method which is called by the thread initiated in Listener class whenever the proxy receives a datagram from the client. This class can include logic for processing the client request. The class can be provided with data from the client as well as the client's IP address and port number. Worker.cpp can include the constants DISPLAY HEIGHT and DISPLAY WIDTH, which contain the value of the target machine's display height and display width. Worker.cpp further can include the constant DISPLAY COLOR, which states whether the display of the target device can support colors.

The mobile proxy component further can generate dbHandler.cpp and dbHandler.h files. The dbHandler file can be included if the developer makes use of the option “Database Support” and wants to connect with a DSN using ODBC. This class can create a CDatabase object whose name is provided by the developer and also provides all the logic to connect to DSN using ODBC. This class should contain all the methods to manipulate the database.

Still, the present invention is not limited only to those functions disclosed herein, nor to the design of proxies for the J2ME platform. Rather, the functions disclosed herein are provided for purposes of illustration and can be provided for any of a variety of available mobile client platforms. For example, additional functionality and API sets can be included to support Transmission Control Protocol (TCP) between client and proxy, Secure Socket Layer (SSL) communications between client, proxy, and other servers, link quality measurement, and measuring client capabilities.

Link quality measurement refers to the quality of wireless links as such links may not remain constant and can vary with movement as well as the position of the user. An API which can measure link quality between proxy and client can provide significant benefits with regard to adapting applications for changing bandwidth, maximum transmission unit (MTU) of datagram packets, jitter, and latency of the link. Accordingly, the proxy can limit the amount of data to be sent to the mobile client in the event the link quality degrades below a threshold point as determined by the aforementioned factors.

Measuring client capabilities refers to dynamically determining the capabilities of the client device. Although the developer can select a device type during generation of the proxy shell, dynamically determining device capability can be useful in situations in which adaptation to client capabilities is desired. For example, such can be the case wherein multiple devices are to be supported. Accordingly, a dynamic determination of parameters such as display area, graphics capabilities, and processor speed can prove to be beneficial.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

### Appendix

Below is an exemplary WSDL document that provides information regarding the interfaces that can be present in an Airline reservation service. The WSDL document provides detailed information regarding the operations involved in accessing this service, messages exchanged in each operation, parameters, and data types of each parameter.

```
<?xml version=“1.0” encoding=“UTF-8”?>
<definitions name=“AirlineBusiness”
      targetNamespace=“http://www.cise.ufl.edu/˜dkochhar/Airline.wsdl”
      xmlns=“http://schemas.xmlsoap.org/wsdl/”
      xmlns:soap=“http://schemas.xmlsoap.org/wsdl/soap/”
      xmlns:tns=““http://www.cise.ufl.edu/˜dkochhar/Airline.wsdl”
      xmlns:xsd=“http://www.w3.org/2001/XMLSchema”>
      <message name=“FindScheduleRequest”>
            <part name=“fromCity” type=“xsd:string”/>
            <part name=“fromState” type=“xsd:string”/>
            <part name=“toCity” type=“xsd:string”/>
            <part name=“toState” type=“xsd:string”/>
            <part name=“departDay” type=“xsd:integer”/>
            <part name=“departMonth” type=“xsd:integer”/>
            <part name=“departYear” type=“xsd:integer”/>
            <part name=“departTime” type=“xsd:decimal”/>
            <part name=“returnDay” type=“xsd:integer”/>
            <part name=“returnMonth” type=“xsd:integer”/>
            <part name=“returnYear” type=“xsd:integer”/>
            <part name=“returnTime” type=“xsd:decimal”/>
            <part name=“numberOfPersons” type=“xsd:integer”/>
            <part name=“isRoundtrip” type=“xsd:boolean”/>
            <part name=“AirlineName” type=“xsd:string”/>
            <part name=“Cabin” type=“xsd:string”/>
      </message>
      <message name=“FindScheduleResponse”>
            <part name=“Airline” type=“xsd:string”/>
            <part name=“flightNumber” type=“xsd:string”/>
            <part name=“fare” type=“xsd:float”/>
            <part name=“journeyId” type=“xsd:string”/>
            <part name=“numberOfSeats” type=“xsd:integer”/>
      </message>
      <message name=“ReservationRequest”>
            <part name=“userName” type=“xsd:string”/>
            <part name=“password” type=“xsd:string”/>
            <part name=“journeyId” type=“xsd:decimal”/>
            <part name=“numberOfPersons” type=“xsd:integer”/>
            <part name=“cabin” type=“xsd:string”/>
      </message>
      <message name=“ReservationResponse”>
            <part name=“confirmationMsg” type=“xsd:string”/>
            <part name=“confirmationNumber” type=“xsd:string”/>
            <part name=“waitingNumber” type=“xsd:string”/>
      </message>
            <portType name=“AirlinePortType”>
                  <operation name=“FindScedule”>
                        <input message=“tns:FindScheduleRequest”/>
                        <output message=“tns:FindScheduleResponse”/>
                  </operation>
                  <operation name=“Reservation”>
                        <input message=“tns:ReservationRequest”/>
                        <output message=“tns:ReservationResponse”/>
                  </operation>
            </portType>
            <binding name=“AirlineBinding” type=“tns:AirlinePortType”>
                  <soap:binding style=“rpc”
                  transport=“http://schemas.xmlsoap.org/soap/http”/>
            <operation name=“FindSchedule”>
                  <soap:operation
                  soapAction=“http://localhost/Airline/FindSchedule”/>
                  <input>
                        <soap:body
                        encodingStyle=“http://schemas.xmlsoap.org/soap/encoding/”
                        namespace=“urn:examples:AirlineService”
                        use=“encoded”/>
                  </input>
                  <output>
                        <soap:body
                        encodingStyle=“http://schemas.xmlsoap.org/soap/encoding/”
                        namespace=“urn:examples:AirlineService”
                        use=“encoded”/>.60
                  </output>
            </operation>
            <operation name=“Reservation”>
                  <soap:operation soapAction=“http://localhost/Airline/Reservation”/>
                  <input>
                        <soap:body
                        encodingStyle=“http://schemas.xmlsoap.org/soap/encoding/”
                        namespace=“urn:examples:AirlineService”
                        use=“encoded”/>
                  </input>
                  <output>
                        <soap:body
                        encodingStyle=“http://schemas.xmlsoap.org/soap/encoding/”
                        namespace=“urn:examples:AirlineService”
                        use=“encoded”/>
                  </output>
            </operation>
      </binding>
      <service name=“AirlineService”>
            <documentation>WSDL File for Airline</documentation>
            <port binding=“tns:AirlineBinding” name=“AirlinePort”>
                  <soap:address
                  location=“http://localhost:8080/soap/services/Airline”/>
            </port>
      </service>
</definitions>
```

1. An integrated development tool for constructing a server-side proxy for interacting with a wireless, mobile device, said integrated development tool comprising:
at least one module, wherein said at least one module is configured to generate program code to perform a specific function of the server-side proxy; and
means for accessing said at least one module.

2. The integrated development tool of claim 1, wherein said means for accessing functions comprise a wizard module for receiving user specified attributes of said server-side proxy, wherein said wizard module controls operation of said at least one module to automatically generate program code specifying a programmatic architecture for the server-side proxy according to the user specified attributes.

3. The integrated development tool of claim 1, wherein said means for accessing functions comprise a toolbar having at least one icon that can be activated via user input.

4. The integrated development tool of claim 1, wherein said at least one module is configured to generate program code to extract text from a markup language document.

5. The integrated development tool of claim 1, wherein said at least one module is configured to generate program code to packetize data according to a type of wireless communications link over which the data is to be sent.

6. The integrated development tool of claim 1, wherein said at least one module is configured to generate program code to convert images from a first graphics format to a second graphics format, wherein the second graphics format is suitable for transmission over a wireless communications link to a mobile device.

7. The integrated development tool of claim 1, wherein said at least one module is configured to generate program code to receive a request originating from the mobile device and generate a hypertext transfer protocol request to an appropriate target.

8. The integrated development tool of claim 1, wherein said at least one module is configured to generate program code to maintain user profiles within a data source accessible to the server-side proxy.

9. The integrated development tool of claim 1, wherein said at least one module is configured to generate program code to manipulate data strings for encoding and decoding data.

10. The integrated development tool of claim 1, further comprising a module configured to search a Universal Description, Discovery, and Integration registry.

11. The integrated development tool of claim 1, further comprising a plurality of standardized Web Services Description Language documents, wherein each Web Services Description Language Document corresponds to a particular domain.

12. The integrated development tool of claim 1, wherein said at least one module is configured to generate program code to measure a quality of a communications link to the wireless, mobile device.

13. A method of constructing a server-side proxy for interacting with a wireless, mobile device comprising:
receiving user input specifying attributes of the server-side proxy; and
automatically generating program code specifying an architecture for the server-side proxy according to the user specified attributes;
wherein the program code is generated by a plurality of modules, each module configured to generate code to perform a particular function of the server-side proxy.

14. The method of claim 13, said automatically generating step comprising generating program code to extract text from a markup language document.

15. The method of claim 13, said automatically generating step comprising generating program code to packetize data according to a type of wireless communications link over which the data is to be sent.

16. The method of claim 13, said automatically generating step comprising generating program code to convert images from a first graphics format to a second graphics format, wherein the second graphics format is suitable for transmission over a wireless communications link to the wireless, mobile device.

17. The method of claim 13, said automatically generating step comprising generating program code to receive a request originating from the mobile device and generate a hypertext transfer protocol request to an appropriate target.

18. The method of claim 13, said automatically generating step comprising generating program code to maintain user profiles within a data source accessible to the server-side proxy.

19. The method of claim 13, said automatically generating step comprising generating program code to manipulate data strings for encoding and decoding data.

20. The method of claim 13, further comprising searching a Universal Description, Discovery, and Integration registry.

21. The method of claim 13, said automatically generating step comprising generating program code to measure a quality of a communications link to the wireless, mobile device.

22. A system for constructing a server-side proxy for interacting with a wireless, mobile device comprising:
means for receiving user input specifying attributes of the server-side proxy; and
means for automatically generating program code specifying an architecture for the server-side proxy according to the user specified attributes.

23. The system of claim 22, said means for automatically generating program code further comprising means for generating program code to extract text from a markup language document.

24. The system of claim 22, said means for automatically generating program code further comprising means for generating program code to packetize data according to a type of wireless communications link over which the data is to be sent.

25. The system of claim 22, said means for automatically generating program code further comprising means for generating program code to convert images from a first graphics format to a second graphics format, wherein the second graphics format is suitable for transmission over a wireless communications link to the wireless, mobile device.

26. The system of claim 22, said means for automatically generating program code further comprising means for generating program code to receive a request originating from the mobile device and generate a hypertext transfer protocol request to an appropriate target.

27. The system of claim 22, said means for automatically generating program code further comprising means for generating program code to maintain user profiles within a data source accessible to the server-side proxy.

28. The system of claim 22, said means for automatically generating program code further comprising means for generating program code to manipulate data strings for encoding and decoding data.

29. The system of claim 22, further comprising means for searching a Universal Description, Discovery, and Integration registry.

30. The system of claim 22, said means for automatically generating program code further comprising means for generating program code to measure a quality of a communications link to the wireless, mobile device.

31. A machine readable storage, having stored thereon a computer program having a plurality of code sections executable by a machine for causing the machine to perform the steps of:
receiving user input specifying attributes of a server-side proxy for a wireless mobile device; and
automatically generating program code specifying an architecture for the server-side proxy according to the user specified attributes;
wherein the program code is generated by a plurality of modules, each module configured to generate code to perform a particular function of the server-side proxy.

32. The machine readable storage of claim 31, said automatically generating step comprising generating program code to extract text from a markup language document.

33. The machine readable storage of claim 31, said automatically generating step comprising generating program code to packetize data according to a type of wireless communications link over which the data is to be sent.

34. The machine readable storage of claim 31, said automatically generating step comprising generating program code to convert images from a first graphics format to a second graphics format, wherein the second graphics format is suitable for transmission over a wireless communications link to the wireless, mobile device.

35. The machine readable storage of claim 31, said automatically generating step comprising generating program code to receive a request originating from the mobile device and generate a hypertext transfer protocol request to an appropriate target.

36. The machine readable storage of claim 31, said automatically generating step comprising generating program code to maintain user profiles within a data source accessible to the server-side proxy.

37. The machine readable storage of claim 31, said automatically generating step comprising generating program code to manipulate data strings for encoding and decoding data.

38. The machine readable storage of claim 31, further comprising searching a Universal Description, Discovery, and Integration registry.

39. The machine readable storage of claim 31, said automatically generating step comprising generating program code to measure a quality of a communications link to the wireless, mobile device.
